(19) United States
(12) Patent Application Publication
(10) Pub. No.: US 2014/0042852 A1
(43) Pub. Date: Feb. 13, 2014

(54) AXIAL FLUX PERMANENT MAGNET MOTOR

(71) Applicant: Samsung Electro-Mechanics Co., Ltd., Suwon (KR)

(72) Inventors: Sang Jong Lee, Suwon (KR); Hee Soo Yoon, Suwon (KR); Han Kyung Bae, Suwon (KR)

(73) Assignee: Samsung Electro-Mechanics Co., Ltd., Suwon (KR)

(21) Appl. No.: 13/954,918

(22) Filed: Jul. 30, 2013

(30) Foreign Application Priority Data
Aug. 13, 2012 (KR) 10-2012-0088445

(51) Int. Cl. H02K 1/17

(52) U.S. Cl. CPC H02K 1/17
USPC 310/154.01

(57) ABSTRACT

Disclosed herein is an axial flux permanent magnet (AFPM) motor including: a stator including a stator core, a magnet wire wound around the stator core, a shaft, and a stator core supporting member fixedly supporting the stator core to the shaft; and a rotor including a rotor case having a space part formed therein so as to receive the stator core therein, a magnet fixedly coupled to an inner side portion of the rotor case so as to face the stator core, and a bearing rotatably supporting the rotor case to the shaft, wherein a ratio between the number of stator slots by the stator core and the number of poles of the rotor by the magnet is (6×n+9):((6×n+9)+1) or (6×n+9):((6×n+9)−1) where n indicates a positive integer number including 0.

### CROSS REFERENCE TO RELATED APPLICATION

This application claims the benefit of Korean Patent Application No. 10-2012-0088445, filed on Aug. 13, 2012, entitled “Axial Flux Permanent Magnet Motor”, which is hereby incorporated by reference in its entirety into this application.

### BACKGROUND OF THE INVENTION

1. Technical Field

The present invention relates to an axial flux permanent magnet (AFPM) motor.

2. Description of the Related Art Generally, a motor includes a rotor in which a magnet is installed and a stator in which a coil is installed, wherein the rotor rotates when voltage is applied to the coil.

As this motor, there art two kinds of motors, that is, an axial flux permanent magnet (AFPM) motor and a radial flux permanent magnet (RFPM) motor.

In addition, the AFPM motor has an axial length significantly shorter than that of the RFPM motor. This feature is very useful for a driving system requiring a motor having a short axial length.

However, most of the motors according to the prior art are the RFPM motor. In the case of the AFPM motor, it is difficult to manufacture a stator core, such that the development of a core scheme is slightly inactive. Therefore, as described in the following Prior Art Document (Patent Document), the AFPM motor according to the prior art has been developed as a coreless motor that does not have a core. However, in the case of the coreless motor, since a coil is disposed at a gap, a wide gap is required, such that large loss is generated and an output in unit volume is low and noise and vibration according to a torque ripple is large as compared with a motor in a core scheme.

### PRIOR ART DOCUMENT

### Patent Document

(Patent Document 1) US 2009-0309430 A1

### SUMMARY OF THE INVENTION

The present invention has been made in an effort to provide an axial flux permanent magnet (AFPM) motor that is capable of obtaining a high output per unit by including a stator core and winding a magnet wire around the stator core and is capable of reducing noise and vibration by configuring a ratio between the number of stator slots by the stator core and the number of poles of the rotor by a magnet to be (6×n+9):((6×n+9)+1) or (6×n+9):((6×n+9)−1) (where n=0, 1, 2 . . . ) to reduce a torque ripple.

According to a preferred embodiment of the present invention, there is provided an AFPM motor including: a stator including a stator core, a magnet wire wound around the stator core, a shaft, and a stator core supporting member fixedly supporting the stator core to the shaft; and a rotor including a rotor case having a space part formed therein so as to receive the stator core therein, a magnet fixedly coupled to an inner side portion of the rotor case so as to face the stator core, and a bearing rotatably supporting the rotor case to the shaft, wherein a ratio between the number of stator slots by the stator core and the number of poles of the rotor by the magnet is (6×n+9):((6×n+9)+1) or (6×n+9):((6×n+9)−1) where n indicates a positive integer number including 0.

The stator core may include magnet wire receiving parts formed at both end portions thereof in a radial direction of the shaft, wherein the magnet wire receiving parts has the magnet wires wound therearound.

The stator core may include guide parts formed at both end portions thereof in an axial direction of the shaft so as to be symmetrical to each other in order to support the magnet wires wound around the magnet wire receiving parts.

The guide part may be connected to the magnet wire receiving part and be protruded to an outer portion of the stator core.

The stator core may be formed by a molding method using a powder magnetic material.

According to another preferred embodiment of the present invention, there is provided an AFPM motor including: a stator including a stator core, a magnet wire wound around the stator core, a shaft, and a stator core supporting member fixedly supporting the stator core to the shaft; and a rotor including a rotor case positioned in parallel with the stator core in a radial direction of the shaft, a magnet fixedly coupled to an inner side portion of the rotor case so as to face the stator core, and a bearing rotatably supporting the rotor case to the shaft, wherein the stator core has one surface coupled to one surface of the stator core supporting member and the other surface positioned so as to face the magnet, and a ratio between the number of stator slots by the stator core and the number of poles of the rotor by the magnet is (6×n+9):((6×n+9)+1) or (6×n+9):((6×n+9)−1) where n indicates a positive integer number including 0.

The stator core may include magnet wire receiving parts formed at both end portions thereof in a radial direction of the shaft, wherein the magnet wire receiving parts has the magnet wires wound therearound.

The stator core may include guide parts formed at both end portions thereof in an axial direction of the shaft so as to be symmetrical to each other in order to support the magnet wires wound around the magnet wire receiving parts.

The guide part may be connected to the magnet wire receiving part and be protruded to an outer portion of the stator core.

The stator core may be formed by a molding method using a powder magnetic material.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a partial cross-sectional view schematically showing an axial flux permanent magnet (AFPM) according to a first preferred embodiment of the present invention;

FIG. 2 is a front view schematically showing one stator core in the AFPM motor shown in FIG. 1;

FIG. 3 is a schematic cross-sectional view of the stator core shown in FIG. 2;

FIG. 4 is a plan view schematically showing one stator core in the AFPM motor shown in FIG. 1;

FIG. 5 is a schematic cross-sectional view of the stator core shown in FIG. 4;

FIG. 6 is a plan view schematically showing a stator core according to a preferred embodiment of the present invention in the AFPM motor shown in FIG. 1;

FIG. 7 is a plan view schematically showing a rotor according to a preferred embodiment of the present invention in the AFPM motor shown in FIG. 1;

FIG. 8 is a plan view schematically showing a rotor according to another preferred embodiment of the present invention in the AFPM motor shown in FIG. 1; and

FIG. 9 is a partial cross-sectional view schematically showing an AFPM according to a second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

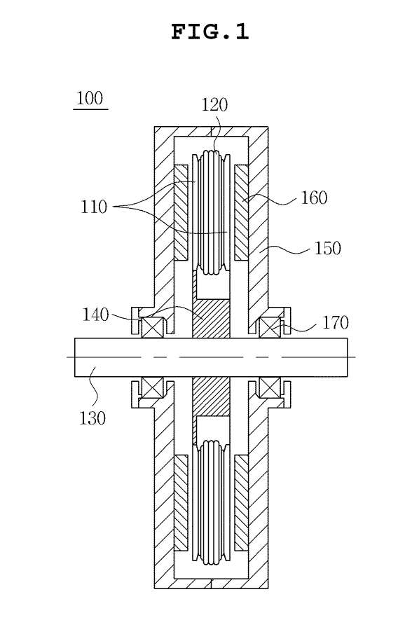

FIG. 1 is a partial cross-sectional view schematically showing an axial flux permanent magnet (AFPM) according to a first preferred embodiment of the present invention. As shown in FIG. 1, the AFPM motor 100 is configured to include a stator including a stator core 110, a magnet wire 120, a shaft 130, and a stator core supporting member 140; and a rotor including a rotor case 150, a magnet 160, and a bearing 170.

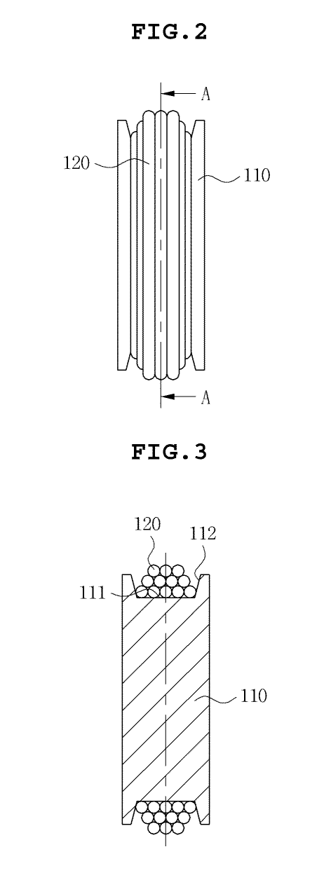

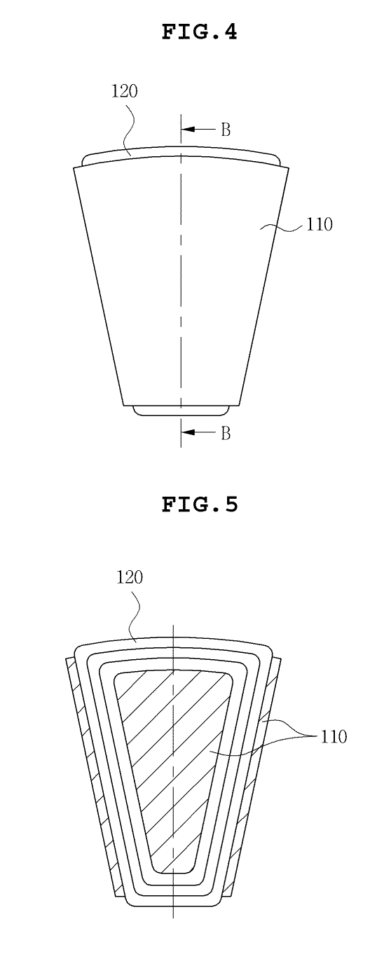

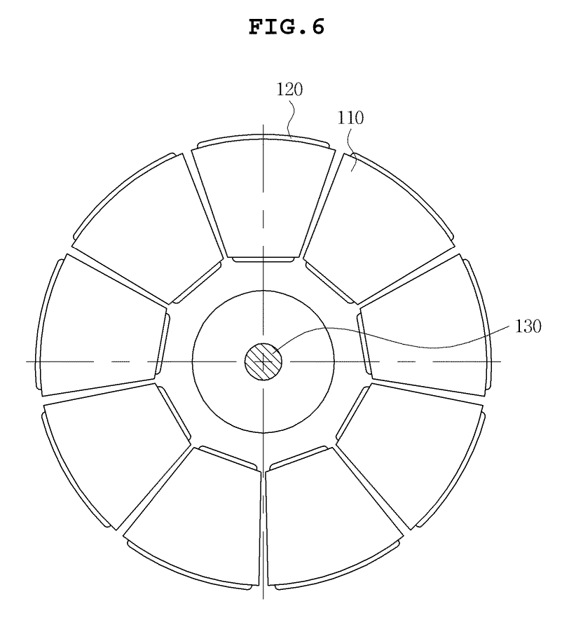

More specifically, as shown in FIGS. 2 to 5, the stator core 110 includes magnet wire receiving parts 111 formed at both end portions thereof in a radial direction of the shaft, wherein the magnet wire receiving parts 111 have the magnet wires 120 wound therearound. In addition, the stator core 110 includes guide parts 112 formed at both end portions thereof in an axial direction of the shaft so as to be symmetrical to each other in order to support the magnet wires 120 wound around the magnet wire receiving parts 111. That is, the guide part 112 is connected to the magnet wire receiving part 111 and is protruded to an outer portion of the stator core 110.

In addition, the stator core 110 may be formed by a molding method using a powder magnetic material.

In addition, the magnet wire 120 is wound around the magnet wire receiving part 111 of the stator core 110 described above. Here, the magnet wire 120 is supported by the guide part 112 of the stator core 110, such that the magnet wire 120 is prevented from being separated from the stator core 110.

In addition, the stator core supporting member 140 fixedly supports the stator core 110 to the shaft 130.

Next, the rotor case 150 of the rotor has a space part formed therein so as to receive the stator core 110 therein. In addition, the rotor case 150 is rotatably supported to the shaft by the bearing 170.

Further, the magnet 160 is fixedly coupled to an inner side portion of the rotor case 150 so as to face the stator core 110.

Further, the magnets 160 of the AFPM motor 100 according to the first preferred embodiment of the present invention are coupled to both inner side portions of the rotor case 150 based on the stator core 110, such that the AFPM motor 100 is implemented as a double rotor structure.

Through the above-mentioned configuration, the AFPM motor 100 according to the first preferred embodiment of the present invention includes the stator core 110, thereby making it possible to obtain a high output in unit volume.

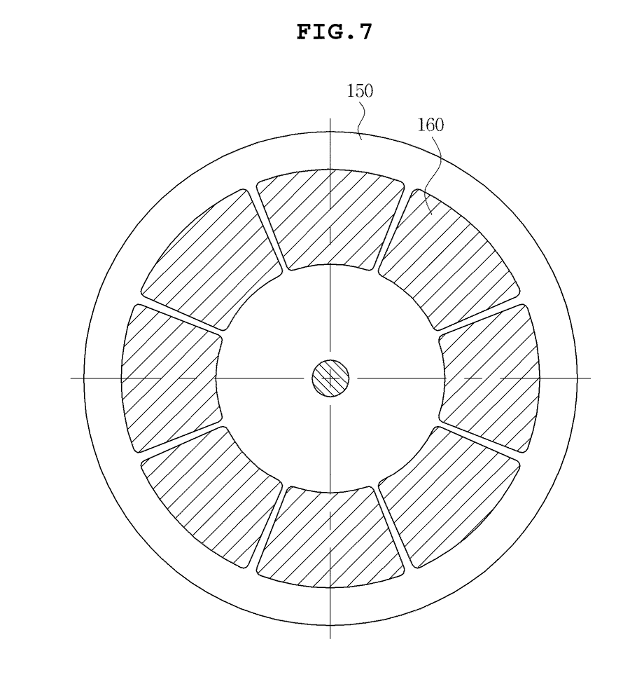

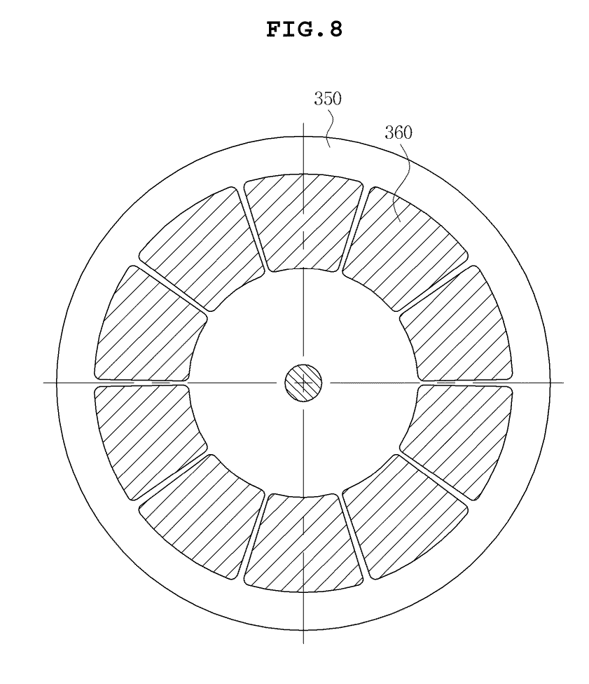

FIG. 6 is a plan view schematically showing a stator core according to a preferred embodiment of the present invention in the AFPM motor shown in FIG. 1; and FIG. 7 is a plan view schematically showing a rotor according to a preferred embodiment of the present invention in the AFPM motor shown in FIG. 1.

In the AFPM motor according to the present invention, a ratio between the number of stator slots by the stator core and the number of poles of the rotor by the magnet according to a preferred embodiment may be (6×n+9):((6×n+9)+1). Where n=0, 1, 2 . . .

In addition, as shown, the AFPM motor shown in FIGS. 6 and 7 has a structure in which it includes ten poles and nine slots. That is, the number of poles of the rotor by the magnet 160 is 10. To this end, ten magnets 160 are provided in the rotor case 150 in a circumferential direction of the shaft 130. In addition, the number of stator slots by the stator core 110 is 9.

FIG. 8 is a plan view schematically showing a rotor according to another preferred embodiment of the present invention in the AFPM motor shown in FIG. 1.

In the AFPM motor according to the present invention, a ratio between the number of stator slots by the stator core and the number of poles of the rotor by the magnet according to another preferred embodiment may be (6×n+9):((6×n+9)−1). Where n=0, 1, 2 . . .

In addition, as shown, in the rotor of the AFPM motor shown in FIG. 8, the number of poles of the rotor by the magnet 360 is 8. To this end, eight magnets 360 are provided in the rotor case 350 in the circumferential direction of the shaft 130.

The following Table 1 shows the number of slots and the number of poles in the case in which the slots and the poles are combined in parallel with each other according to a multiple of n.

TABLE 1

| | Basic Ratio | | 2 Parallel | | 3 Parallel | |
|---|---|---|---|---|---|---|
| Multiple | Number of | Number of | Number of | Number of | Number of | Number of |
| of n | Stator Slots | Poles of Rotor | Stator Slots | Poles of Rotor | Stator Slots | Poles of Rotor |
| 0 | 9 | 8 | 18 | 18 | 27 | 24 |
| 0 | 9 | 10 | 18 | 20 | 27 | 30 |
| 1 | 15 | 14 | 30 | 28 | 45 | 42 |
| 1 | 15 | 18 | 30 | 32 | 45 | 48 |
| 2 | 21 | 20 | 42 | 40 | 63 | 60 |
| 2 | 21 | 22 | 42 | 44 | 63 | 65 |
| 3 | 27 | 26 | 54 | 52 | 81 | 78 |
| 3 | 27 | 28 | 54 | 56 | 81 | 84 |
| 4 | 33 | 32 | 66 | 54 | 99 | 96 |
| 4 | 33 | 34 | 66 | 68 | 99 | 102 |
| 5 | 39 | 38 | 78 | 76 | 117 | 114 |
| 5 | 45 | 48 | 90 | 92 | 135 | 138 |
| . . . | . . . | . . . | . . . | . . . | . . . | . . . |

Through the above-mentioned configuration, the AFPM has a reduced torque. Therefore, it is possible to provide the AFPM motor having reduced noise and vibration.

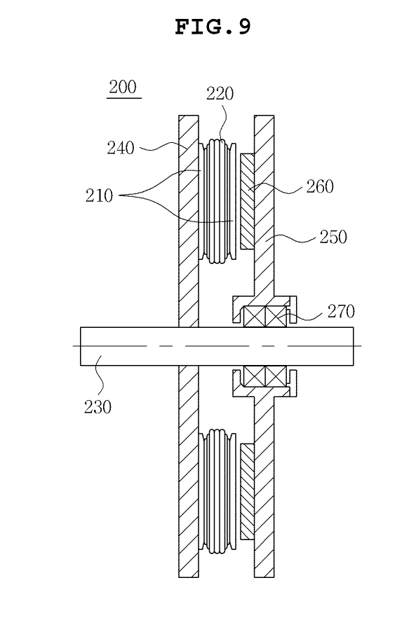

FIG. 9 is a partial cross-sectional view schematically showing an AFPM according to a second preferred embodiment of the present invention. As shown in FIG. 9, the AFPM motor 200 is the same as the AFPM motor 100 according to the first preferred embodiment of the present invention except for a structure of a rotor.

More specifically, the AFPM motor 200 is configured to include: a stator including a stator core 210, a magnet wire 220, a shaft 230, and a stator core supporting member 240; and a rotor including a rotor case 250, a magnet 260, and a bearing 270.

In addition, the rotor case 250 is rotatably supported to the shaft by the bearing 270 so as to face and be in parallel with the stator core 210 in a radial direction of the shaft 230.

Further, the stator core 210 has one surface coupled to one surface of the stator core supporting member 240 and the other surface positioned so as to face the magnet.

That is, the magnet 260 of the AFPM motor 200 according to the second preferred embodiment of the present invention faces the stator core 210 and is coupled to an inner side portion of the rotor case 250, such that the AFPM motor 200 is implemented as a single rotor structure.

In addition, in the AFPM motor according to the second preferred embodiment of the present invention, a ratio between the number of stator slots by the stator core and the number of poles of the rotor by the magnet according to another preferred embodiment may be (6×n+9):((6×n+9)+1) or (6×n+9):((6×n+9)−1). Where n=0, 1, 2 . . .

As set forth above, according to the preferred embodiments of the present invention, it is possible to provide an AFPM motor that is capable of obtaining a high output per unit by including a stator core and winding a magnet wire around the stator core and is capable of reducing noise and vibration by configuring a ratio between the number of stator slots by the stator core and the number of poles of the rotor by a magnet to be (6×n+9):((6×n+9)+1) or (6×n+9):((6×n+9)−1) (where n=0, 1, 2 . . . ) to reduce a torque ripple.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An axial flux permanent magnet (AFPM) motor comprising:
a stator including a stator core, a magnet wire wound around the stator core, a shaft, and a stator core supporting member fixedly supporting the stator core to the shaft; and
a rotor including a rotor case having a space part formed therein so as to receive the stator core therein, a magnet fixedly coupled to an inner side portion of the rotor case so as to face the stator core, and a bearing rotatably supporting the rotor case to the shaft,
wherein a ratio between the number of stator slots by the stator core and the number of poles of the rotor by the magnet is (6×n+9):((6×n+9)+1) or (6×n+9):((6×n+9)−1) where n indicates a positive integer number including 0.

2. The AFPM motor as set forth in claim 1, wherein the stator core includes magnet wire receiving parts formed at both end portions thereof in a radial direction of the shaft, the magnet wire receiving parts having the magnet wires wound therearound.

3. The AFPM motor as set forth in claim 2, wherein the stator core includes guide parts formed at both end portions thereof in an axial direction of the shaft so as to be symmetrical to each other in order to support the magnet wires wound around the magnet wire receiving parts.

4. The AFPM motor as set forth in claim 3, wherein the guide part is connected to the magnet wire receiving part and is protruded to an outer portion of the stator core.

5. The AFPM motor as set forth in claim 1, wherein the stator core is formed by a molding method using a powder magnetic material.

6. An AFPM motor comprising:
a stator including a stator core, a magnet wire wound around the stator core, a shaft, and a stator core supporting member fixedly supporting the stator core to the shaft; and
a rotor including a rotor case positioned in parallel with the stator core in a radial direction of the shaft, a magnet fixedly coupled to an inner side portion of the rotor case so as to face the stator core, and a bearing rotatably supporting the rotor case to the shaft,
wherein the stator core has one surface coupled to one surface of the stator core supporting member and the other surface positioned so as to face the magnet, and a ratio between the number of stator slots by the stator core and the number of poles of the rotor by the magnet is (6×n+9):((6×n+9)+1) or (6×n+9):((6×n+9)−1) where n indicates a positive integer number including 0.

7. The AFPM motor as set forth in claim 6, wherein the stator core includes magnet wire receiving parts formed at both end portions thereof in a radial direction of the shaft, the magnet wire receiving parts having the magnet wires wound therearound.

8. The AFPM motor as set forth in claim 7, wherein the stator core includes guide parts formed at both end portions thereof in an axial direction of the shaft so as to be symmetrical to each other in order to support the magnet wires wound around the magnet wire receiving parts.

9. The AFPM motor as set forth in claim 8, wherein the guide part is connected to the magnet wire receiving part and is protruded to an outer portion of the stator core.

10. The AFPM motor as set forth in claim 8, wherein the stator core is formed by a molding method using a powder magnetic material.
